(19) United States
(12) Patent Application Publication
(10) Pub. No.: US 2023/0236368 A1
(43) Pub. Date: Jul. 27, 2023

(54) OPTICAL MODULE PACKAGE USING BI-ANGLED SILICA WAVEGUIDE

(71) Applicant: Korea Advanced Institute of Science and Technology, Daejeon (KR)

(72) Inventors: Hyo-Hoon Park, Daejeon (KR); HyunHo Yun, Daejeon (KR); Jaeyong Kim, Daejeon (KR)

(73) Assignee: Korea Advanced Institute of Science and Technology, Daejeon (KR)

(21) Appl. No.: 17/684,895

(22) Filed: Mar. 2, 2022

(30) Foreign Application Priority Data
Jan. 27, 2022 (KR) 10-2022-0011916

(51) Int. Cl. G02B 6/42

(52) U.S. Cl. CPC G02B 6/4214; G02B 6/42

(57) ABSTRACT

An optical module package using a bidirectional polished silica optical waveguide is disclosed. An optical module package may include a planar optical waveguide that connects at least one aperture of each of the optical components and including inclined surfaces at both ends thereof to allow light, which exits from at least one aperture of any one optical component of the optical components to be subjected to optical coupling in a vertical direction through total reflection on an inclined surface corresponding to the at least one aperture of the any one optical component to cause the light to travel in a horizontal direction, and allows the light to be subjected to optical coupling to at least one aperture of a remaining optical component in the vertical direction through total reflection on the inclined surface corresponding to the at least one aperture of the remaining optical component.

### CROSS-REFERENCE TO RELATED APPLICATIONS

A claim for priority under 35 U.S.C. § 119 is made to Korean Patent Application No. 10-2022-0011916 filed on Jan. 27, 2021 in the Korean Intellectual Property Office, the entire contents of which are hereby incorporated by reference.

### BACKGROUND

Embodiments of the inventive concept described herein relate to an optical package that interconnects optical components such as chips or light sources, and more particularly, relate to an optical module package using a bidirectional polished silica optical waveguide.

Recently, trends of using optical connections for information transmission in data centers is spreading in order to accommodate the rapidly increasing data traffic. To this end, silicon photonics-based optical module packages that are advantageous for low cost and mass production are being actively researched and developed. Currently, optical connection between data center servers is the main demand, but it is expected that optical connection will be unavoidable for data transmission between chips and a light source and a chip inside high-performance server computers in the near future. Thus, the development of an optical module package that enables short-range (cm unit) optical connection is essential.

When existing optical-fiber connection used for long-distance transmission, such as the optical connection between systems, is used for the short-distance (cm unit) connection between chips or a light source and a chip, a non-planar optical module package, which has vertical optical coupling, is difficult to integrate and miniaturize, and has disadvantages of being vulnerable to external impact.

Accordingly, an angled fiber-based optical module package that enables optical coupling by polishing both ends of an optical fiber to have an inclination angle capable of total reflection has been proposed.

However, since the angled fiber-based optical module package has a distance of 60 µm from a core to an optical component (thickness of a lower clad positioned below the core), there is a disadvantage in that the optical loss due to optical dispersion is large.

Accordingly, the following embodiments propose an optical module package having a light coupling efficiency equivalent to the level of the described conventional optical fiber, enabling stable packaging, simplifying the manufacturing process, and having a structure advantageous for integration.

### SUMMARY

Embodiments of the inventive concept provide an optical module package including a planar optical waveguide configured using silica planar lightwave circuit technology, to secure optical coupling efficiency comparable to the level of optical fibers, enable stable packaging, and simplify the manufacturing process, thus achieving mass production and low cost and providing a structure advantageous for integration.

However, the technical problems to be solved by the inventive concept are not limited to the above problems, and may be variously expanded without departing from the technical spirit and scope of the inventive concept.

According to an exemplary embodiment, an optical module package includes optical components each including at least one aperture through which light enters and exits and a planar optical waveguide that connects at least one aperture of each of the optical components and including inclined surfaces at both ends thereof to allow light, which exits from at least one aperture of any one optical component of the optical components to be subjected to optical coupling in a vertical direction through total reflection on an inclined surface corresponding to the at least one aperture of the any one optical component to cause the light to travel in a horizontal direction, and allows the light to be subjected to optical coupling to at least one aperture of a remaining optical component in the vertical direction through total reflection on the inclined surface corresponding to the at least one aperture of the remaining optical component.

According to another exemplary embodiment, the planar optical waveguide may include a lower clad made of silica, at least one waveguide core- the at least one waveguide core being formed in a single, multiple, or array form on the lower clad- and a clad film - the clad film being formed on at least one waveguide core.

According to still another exemplary embodiment, the lower clad may be formed to have a thickness that minimizes light loss caused by optical dispersion when light is optically coupled to the at least one waveguide core from at least one aperture of the optical components or when light is optically coupled to at least one aperture of the optical components from the at least one waveguide core.

According to still another exemplary embodiment, the lower clad may have a thickness of 10 µm.

According to still another exemplary embodiment, the at least one waveguide core may be configured such that the light guided in the horizontal direction travels in a straight line.

According to still another exemplary embodiment, the at least one waveguide core may be formed in a branchable structure, a structure that is fan-out in a waveguide direction, or a structure that is fan-in in the waveguide direction.

According to still another exemplary embodiment, the at least one waveguide core may be spaced apart in a traverse direction and are provided in plural.

According to still another exemplary embodiment, the at least one aperture of each of the optical components may be provided in plural in a multiple or array form, and the at least one waveguide core may be spaced apart in a longitudinal direction and provided in plural to form a plurality of layers and is multi-optically coupled to the apertures of each of the optical components in response to a change in height at which light exiting from each of the apertures of the exit optical component is totally reflected.

According to still another exemplary embodiment, each of the inclined surfaces at both ends of the planar optical waveguide may be formed to be polished to have an inclination angle of a value that satisfies a total reflection condition of each of the inclined surfaces.

According to still another exemplary embodiment, each of the optical components may be a silicon-based photonic integrated circuit chip (PIC), or a vertical cavity surface emitting laser (VCSEL).

According to still another exemplary embodiment, at least one aperture of each of the optical components may be a grating coupler when each of the optical components is a silicon-based optical integrated chip.

According to an exemplary embodiment, an optical module package includes optical components each including at least one aperture through which light enters and exits: and a silica-based planar optical waveguide that connects at least one aperture of each of the optical components and including inclined surfaces at both ends thereof to allow light, which exits from at least one aperture of any one optical component of the optical components to be subjected to optical coupling in a vertical direction through total reflection on an inclined surface corresponding to the at least one aperture of the any one optical component to cause the light to travel in a horizontal direction, and allows the light to be subjected to optical coupling to at least one aperture of a remaining optical component in the vertical direction through total reflection on the inclined surface corresponding to the at least one aperture of the remaining optical component, wherein the planar optical waveguide includes a lower clad made of silica, at least one waveguide core- the at least one waveguide core being formed in a single, multiple, or array form on the lower clad- and a clad film - the clad film being formed on at least one waveguide core, and wherein the lower clad is formed to have a thickness that minimizes light loss caused by optical dispersion when light is optically coupled to the at least one waveguide core from at least one aperture of the optical components or when light is optically coupled to at least one aperture of the optical components from the at least one waveguide core.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a side cross-sectional view showing an optical module package according to an embodiment;

FIG. 2 is a plan view for describing connection between an optical chip and a planar optical waveguide when an optical component is the optical chip;

FIG. 3 is a side cross-sectional view for describing connection between an optical chip and a planar optical waveguide when an optical component is the optical chip;

FIG. 4 is a plan view for describing connection between a light source and a planar optical waveguide when an optical component is the light source;

FIG. 5 is a side cross-sectional view for describing connection between a light source and a planar optical waveguide when an optical component is the light source; and

FIGS. 6 to 10 are diagrams for describing various implementation examples of at least one planar optical waveguide included in an optical module package according to an embodiment.

### DETAILED DESCRIPTION

Hereinafter, embodiments of the inventive concept will be described in detail with reference to the exemplary drawings. However, it will be understood that the inventive concept is by no means restricted or limited in any manner by these embodiments. In addition, the same reference numeral shown in each drawing indicates the same element.

In addition, terminologies used in the present specification are used to properly express preferred embodiments of the inventive concept, and may be changed depending on the intention of viewers or operators, or customs in the field to which the inventive concept belongs. Accordingly, definitions of these terminologies should be made based on the content throughout this specification. For example, the singular expressions include plural expressions unless the context clearly dictates otherwise. Also, in this specification, the terms “comprises” and/or “comprising” are intended to specify the presence of stated features, integers, steps, operations, elements, parts or combinations thereof, but do not preclude the presence or addition of steps, operations, elements, parts, or combinations thereof. In addition, although terminologies such as first and second are used in this specification to describe various regions, directions, shapes, etc., these regions, directions, and shapes should not be limited by these terms. These terminologies are only used to distinguish one region, direction, or shape from another. Accordingly, a part referred to as the first part in one embodiment may be referred to as the second part in another embodiment.

Also, it should be understood that various embodiments of the inventive concept are different from each other but are not necessarily mutually exclusive. For example, specific shapes, structures, and characteristics described herein may be implemented in other embodiments without departing from the spirit and scope of the inventive concept in relation to one embodiment. In addition, it should be understood that the position, arrangement, or configuration of individual components in each of the presented embodiment categories may be changed without departing from the spirit and scope of the inventive concept.

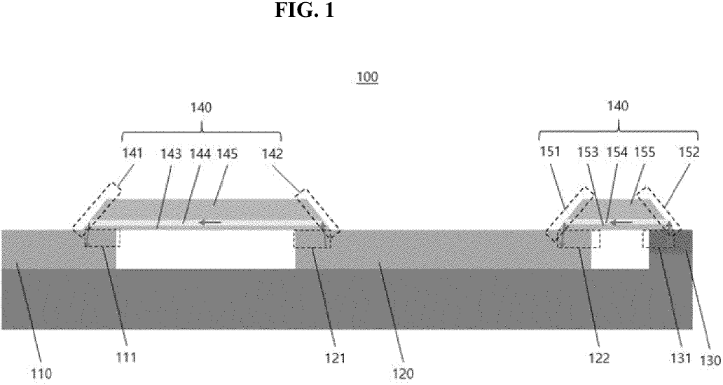

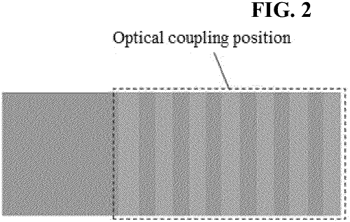

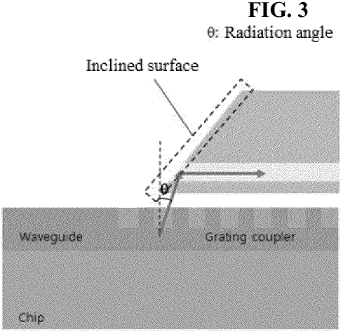

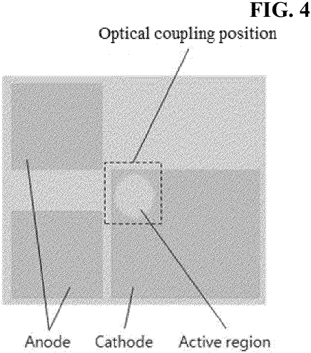

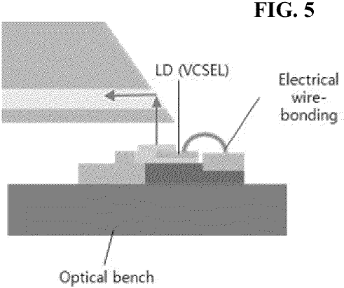

FIG. 1 is a side cross-sectional view showing an optical module package according to an embodiment, FIG. 2 is a plan view for describing connection between an optical chip and a planar optical waveguide when an optical component is the optical chip, FIG. 3 is a side cross-sectional view for describing connection between an optical chip and a planar optical waveguide when an optical component is the optical chip, and FIG. 4 is a plan view for describing connection between a light source and a planar optical waveguide when an optical component is the light source, and FIG. 5 is a side cross-sectional view for describing connection between a light source and a planar optical waveguide when an optical component is the light source.

Referring to FIGS. 1 to 5, an optical module package 100 according to an embodiment may include optical components 110, 120, and 130 respectively including at least one aperture 111, 121, 122, and 131 through which light enters and exits and planar optical waveguides 140 and 150 connecting the at least one aperture 111, 121, 122, or 131 of each of the optical components 110, 120, and 130, and inclined surfaces 141 and 142, and 151 and 152 at both ends of the planar optical waveguides 140 and 150. For example, the first optical component 110 that is an optical chip may include the first aperture 111, the second optical component 120 that is an optical chip may include the 2-1-th aperture 121 and the 2-2-th aperture 122, and the third optical component 130 serving as the light source may include the third aperture 131. Accordingly, the first planar optical waveguide 140 may connect the first aperture 111 and the 2-1-th aperture 121 and include the inclined surfaces 141 and 142 at both ends thereof, and the second planar optical waveguide 150 may connect the 2-2-th aperture 122 and the third aperture 131 and include the inclined surfaces 151 and 152 at both ends thereof.

Hereinafter, the optical chip may refer to a silicon-based photonic integrated circuit chip (PIC), and the light source may refer to a light source with a vertical emission structure (vertical cavity surface emitting laser: VCSEL). When the optical component 130 is an optical chip, at least one aperture 131 of the optical component 130 may be a grating coupler.

The planar optical waveguides 140 and 150 may be characterized in that they are constructed based on silica by utilizing a standard fabrication process of a silica planar lightwave circuit technology. In more detail, the planar optical waveguides 140 or 150 may include a lower clad 143 or 153 made of silica, at least one waveguide core 144 or 154 formed in a single, multiple, or array form on the lower clad 143 or 153 made of silica, and a clad film 145 or 155 formed on at least one waveguide core 144 or 154 made of silica.

Here, the lower clad 143 or 153 may be formed to have a thickness that minimizes light loss caused by optical dispersion when light is optically coupled to the at least one waveguide core 144 or 154 from at least one aperture 111, 121, 122 or 131 of the optical components 110, 120 or 130, or when light is optically coupled to at least one aperture 111, 121, 122 or 131 of the optical components 110, 120 or 130 from the at least one waveguide core 144 or 154. For example, the lower clads 143 and 153 may be formed to have a thickness of 10 µm.

The at least one waveguide core 144 or 154 may be configured such that light directed in a horizontal direction is guided in a straight line.

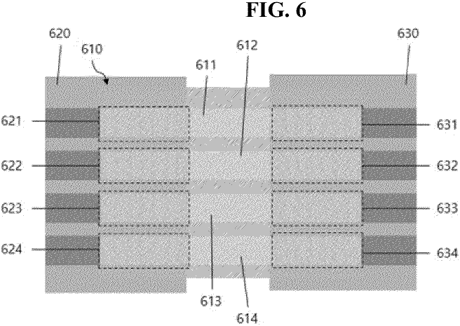

In addition, the at least one waveguide core 144 or 154 may be provided in plurality and spaced apart in the transverse direction. The at least one waveguide core 144 or 154 may be formed in a branchable structure, in a structure that is fan-out along the waveguide direction, or in a structure that is fan-in along the waveguide direction. A detailed description thereof will be described with reference to FIGS. 6 to 10 below.

Such the planar optical waveguide 140 may guide light by allowing light, which exists from at least one aperture 111 of any one optical component 110 of the optical components 110 and 120 to be subjected to optical coupling in a vertical direction through total reflection on the inclined surface 141 corresponding to the at least one aperture 111 of the any one optical component 110 to cause the light to travel in a horizontal direction, and then allowing the light to be subjected to optical coupling to at least one aperture 121 of the remaining optical component 120 of the optical components 110 and 120 in the vertical direction through total reflection on the inclined surface 142 corresponding to the at least one aperture 121 of the remaining optical component 120.

The described optical coupling and optical waveguide may also be performed in the reverse direction. For example, the planar optical waveguide 140 may guide light by allowing light, which exits from at least one aperture 111 of any one optical component 110 of the optical components 110 and 120 to be subjected to optical coupling in a vertical direction through total reflection on the inclined surface 141 corresponding to the at least one aperture 111 of the any one optical component 110 to cause the light to travel in a horizontal direction, and then allowing the light to be subjected to optical coupling to at least one aperture 111 of the remaining optical component 110 of the optical components 110 and 120 in the vertical direction through total reflection on the inclined surface 141 corresponding to the at least one aperture 111 of the remaining optical component 110.

Similarly, the planar optical waveguide 150 may guide light by allowing light, which exits from at least one aperture 122 of any one optical component 120 of the optical components 120 and 130 to be subjected to optical coupling in a vertical direction through total reflection on the inclined surface 151 corresponding to the at least one aperture 122 of the any one optical component 120 to cause the light to travel in the horizontal direction, and then allowing the light to be subjected to optical coupling to the at least one aperture 131 of the remaining optical component 130 in the vertical direction through total reflection on the inclined surface 152 corresponding to the at least one aperture 131 of the remaining optical component 130.

The described optical coupling and optical waveguide may also be performed in the reverse direction.

In this case, each of the inclined surfaces 141 and 142 and 151 and 152 at both ends of the planar optical waveguide 140 and 150 may be formed to be polished to have an inclination angle.

For example, as shown in FIGS. 2 and 3, the inclination angle of the inclined surfaces 141, 142, and 151 of the planar optical waveguides 140 and 150 connected to the optical components 110 and 120, which are optical chips, may be determined based on an radiation angle of the grating which is at least one aperture 111, 121, 122 of the optical components 110 and 120 to satisfy the condition of total reflection of light. Since the radiation angle of the grating, which is the at least one aperture 111, 121 and 122 of the optical component 110 and 120, is determined according to the period of the grating, which is the at least one aperture 111, 121, 122 of the optical component 110 and the inclination angles of the inclined surfaces 141, 142, and 151 of the planar optical waveguides 140 and 150 connected to the optical components 110 and 120, which are optical chips, may be determined based on the period of the grating, which is the at least one aperture 111, 121, 122 of the planar optical waveguides 140 and 150, to satisfy the condition of total reflection of light.

For a more specific example, when the period of the grating, which is the at least one aperture 111, 121, 122 of the optical components 110 and is 620 nm, the reflection of light of the grating which is at least one aperture 111, 121 or 122 of the optical components 110 or 120 may be 8 degrees. Accordingly, in order to satisfy the condition for total reflection of light on the assumption that the radiation angle of the grating, which is at least one aperture 111, 121, 122 of the optical components 110 and 120, is 8 to 10 degrees, the inclined surfaces 141, 142, and 151 of the planar optical waveguides 140 and 150 connected to the optical components 110 and 120 which are optical chip may be formed to be polished to have an inclination angle of 40 to 41 degrees.

For another example, as shown in FIGS. 4 and 5, the inclination angle of the inclined surface 152 of the planar optical waveguide 150 connected to the optical component 130, which is a light source, may be determined based on a radiation angle of the grating which is the at least one aperture 131 of the optical component 130 to satisfy the condition of total reflection of light. The radiation angle of the grating, which is at least one of the apertures 111, 121, 122 of the optical components 110 and 120, may have a value of zero degrees in the vertical direction since the optical components 110 and 120 are light sources. Accordingly, in order to satisfy the condition for total reflection of light on the assumption that the radiation angle of the grating, which is at least one aperture 131 of the optical component 130, is 0 degree, the inclination angle of the inclined surface 152 of the planar optical waveguide 150 connected to the optical component 130 may be formed to be polished to have an inclination angle of 45 degrees.

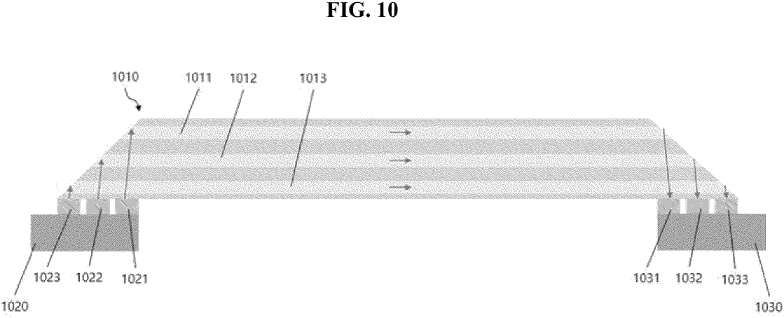

FIGS. 6 to 10 are diagrams for describing various implementation examples of at least one planar optical waveguide included in an optical module package according to an embodiment. In more detail, FIGS. 6 to 9 are plan views illustrating various implementation examples of at least one planar optical waveguide, and FIG. 10 is a side cross-sectional view illustrating various implementation examples of at least one planar optical waveguide.

Referring to FIG. 6, a planar optical waveguide 610 may include a plurality of waveguide cores 611, 612, 613, and 614 spaced apart in the transverse direction. In this case, the waveguide cores 611, 612, 613, and 614 may have an arrangement form in which the waveguide cores 611, 612, 613, and 614 are spaced apart from each other in the transverse direction by a predetermined interval, and may be optically coupled to the plurality of apertures 621, 622, 623, 624, 631, 632, 633, 634 of the optical components 620 and 630 (the plurality of apertures 621, 622, 623, 624, 631, 632, 633, 634 are also configured in a multiple or arrangement form).

Accordingly, light exiting from the first aperture 621 of the exit optical component 620 may be guided through the first waveguide core 611 and optically coupled to the first aperture 631 of the incident optical component 630. Light exiting from the second aperture 622 of the exit optical component 620 may be guided through the second waveguide core 612 and optically coupled to the second aperture 632 of the incident optical component 630. Light exiting from the third aperture 623 of the exit optical component 620 may be guided through the third waveguide core 613 and optically coupled to the third aperture 633 of the incident optical component 630. Light exiting from the fourth aperture 624 of the exit optical component 620 may be guided through the fourth waveguide core 614 and optically coupled to the fourth aperture 634 of the incident optical component 630.

The predetermined interval by which the waveguide cores 611, 612, 613, and 614 are spaced apart may be adjusted to a value of several tens of µm under the precondition that does not allow interference between the waveguide cores. Also, the intervals between the waveguide cores 611, 612, 613, and 614 may be adjusted to be different from each other.

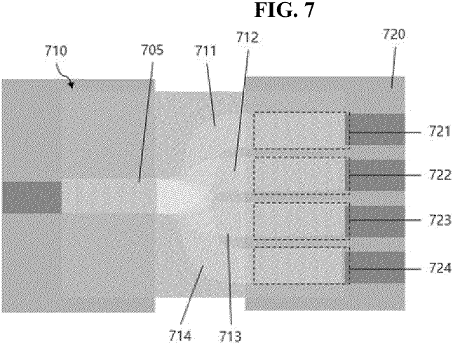

Referring to FIG. 7, a planar optical waveguide 710 may be implemented in a branchable structure such as an M*N optical splitter. In this case, the light guided through a waveguide core 705 may be branched and guided into a first waveguide core 711, a second waveguide core 712, a third waveguide core 713, and a fourth waveguide core 714 through a beam splitter as shown in drawings. Accordingly, light guided through the first waveguide core 711 may be optically coupled to a first aperture 721 of an optical component 720, light guided through the second waveguide core 712 may be optically coupled to a second aperture 722 of the optical component 720, light guided through the third waveguide core 713 may be optically coupled to a third aperture 723 of the optical component 720, and light guided through the fourth waveguide core 714 may be optically coupled to a fourth aperture 724 of the optical component 720.

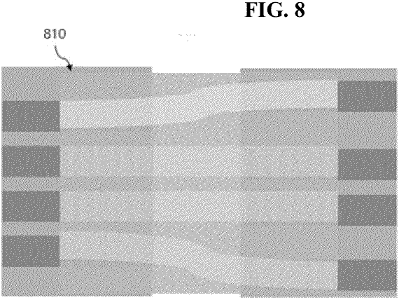

Referring to FIG. 8, a planar optical waveguide 810 may be formed in a structure that is fan-out in a waveguide direction. Even in this case, as described with reference to FIG. 6, a plurality of waveguide cores of the planar optical waveguide 810 may be spaced apart in the transverse direction. However, it is not limited or restricted thereto.

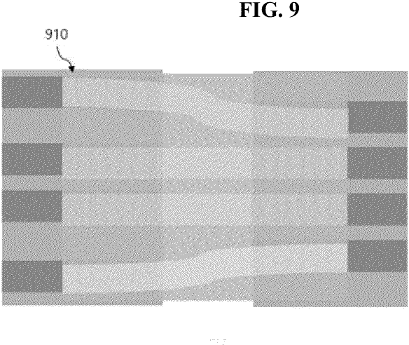

Referring to FIG. 9, a planar optical waveguide 910 may be formed in a structure that is fan-in in a waveguide direction. Even in this case, as described with reference to FIG. 6, a plurality of waveguide cores of the planar optical waveguide 910 may be spaced apart in the transverse direction. However, it is not limited or restricted thereto.

Referring to FIG. 10, a planar optical waveguide 1010 may include a plurality of waveguide cores 1011, 1012, and 1013 spaced apart in the longitudinal direction to form a plurality of layers. In this case, the waveguide cores 1011, 1012, and 1013 may have an arrangement form spaced apart from each other in the longitudinal direction at regular intervals, and the plurality of apertures 1021, 1022, 1023, 1031, 1032, and 1033 may be optically coupled to each other (the plurality of apertures 1021, 1022, 1023, 1031, 1032, and 1033 may also be configured in a multiple or array form).

Accordingly, the waveguide cores 1011, 1012, and 1013 may be multi-optically coupled to the apertures 1031, 1032, and 1033 respectively in response to a change in height at which light exiting from each of the apertures 1021, 1022, and 1023 of the exit optical component 1020 is totally reflected.

Even in this case, as described with reference to FIG. 6, the waveguide cores 1011, 1012, and 1013 are spaced apart in the transverse direction and may be provided in plurality. That is, the plurality of waveguide cores 1011, 1012, and 1013 may be provided in plurality in the longitudinal direction and the transverse direction. However, it is not limited or restricted thereto.

Although the embodiments have been described by the limited embodiments and the drawings as described above, various modifications and variations are possible to those skilled in the art from the above description. For example, the described techniques may be performed in a different order than the described method, and / or elements of the described systems, structures, devices, circuits, etc. may be combined or combined in a different form than the described method, or other elements, or even when replaced or substituted by equivalents, an appropriate result can be achieved.

Therefore, other implementations, other embodiments, and equivalents to the claims are within the scope of the following claims.

The embodiments may provide an optical module package including a planar optical waveguide configured using silica planar lightwave circuit technology, to secure optical coupling efficiency comparable to the level of optical fibers, enable stable packaging, and simplify the manufacturing process, thus achieving mass production and low cost and providing a structure advantageous for integration.

However, the effects of the inventive concept are not limited to the above effects, and may be variously expanded without departing from the spirit and scope of the inventive concept.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. An optical module package comprising:
optical components each including at least one aperture through which light enters and exits: and
a planar optical waveguide configured to connect at least one aperture of each of the optical components and including inclined surfaces at both ends thereof to allow light, which exits from at least one aperture of any one optical component of the optical components to be subjected to optical coupling in a vertical direction through total reflection on an inclined surface corresponding to the at least one aperture of the any one optical component to cause the light to travel in a horizontal direction, and allow the light to be subjected to optical coupling to at least one aperture of a remaining optical component in the vertical direction through total reflection on the inclined surface corresponding to the at least one aperture of the remaining optical component.

2. The optical module package of claim 1, wherein the planar optical waveguide includes a lower clad made of silica, at least one waveguide core- the at least one waveguide core being formed in a single, multiple, or array form on the lower clad- and a clad film - the clad film being formed on at least one waveguide core.

3. The optical module package of claim 2, wherein the lower clad is formed to have a thickness that minimizes light loss caused by optical dispersion when light is optically coupled to the at least one waveguide core from at least one aperture of the optical components or when light is optically coupled to at least one aperture of the optical components from the at least one waveguide core.

4. The optical module package of claim 3, wherein the lower clad has a thickness of 10 µm.

5. The optical module package of claim 2, wherein the at least one waveguide core is configured such that the light guided in the horizontal direction travels in a straight line.

6. The optical module package of claim 5, wherein the at least one waveguide core is formed in a branchable structure, a structure that is fan-out in a waveguide direction, or a structure that is fan-in in the waveguide direction.

7. The optical module package of claim 2, wherein the at least one waveguide core are spaced apart in a traverse direction and are provided in plural.

8. The optical module package of claim 2, wherein the at least one aperture of each of the optical components is provided in plural in a multiple or array form, and
wherein the at least one waveguide core is spaced apart in a longitudinal direction and provided in plural to form a plurality of layers and is multi-optically coupled to the apertures of each of the optical components in response to a change in height at which light exiting from each of the apertures of the exit optical component is totally reflected.

9. The optical module package of claim 1, wherein each of the inclined surfaces at both ends of the planar optical waveguide is formed to be polished to have an inclination angle of a value that satisfies a total reflection condition of each of the inclined surfaces.

10. The optical module package of claim 1, wherein each of the optical components is a silicon-based photonic integrated circuit chip (PIC), or a vertical cavity surface emitting laser (VCSEL).

11. The optical module package of claim 10, wherein the at least one aperture of each of the optical components is a grating coupler when each of the optical components is a silicon-based optical integrated chip.

12. An optical module package comprising:
optical components each including at least one aperture through which light enters and exits; and
a silica-based planar optical waveguide configured to connect at least one aperture of each of the optical components and including inclined surfaces at both ends thereof to allow light, which exits from at least one aperture of any one optical component of the optical components to be subjected to optical coupling in a vertical direction through total reflection on an inclined surface corresponding to the at least one aperture of the any one optical component to cause the light to travel in a horizontal direction, and allow the light to be subjected to optical coupling to at least one aperture of a remaining optical component in the vertical direction through total reflection on the inclined surface corresponding to the at least one aperture of the remaining optical component,
wherein the planar optical waveguide includes a lower clad made of silica, at least one waveguide core- the at least one waveguide core being formed in a single, multiple, or array form on the lower clad- and a clad film - the clad film being formed on at least one waveguide core, and
wherein the lower clad is formed to have a thickness that minimizes light loss caused by optical dispersion when light is optically coupled to the at least one waveguide core from at least one aperture of the optical components or when light is optically coupled to at least one aperture of the optical components from the at least one waveguide core.
